(19) United States
(12) Patent Application Publication
(10) Pub. No.: US 2026/0066436 A1
(43) Pub. Date: Mar. 5, 2026

(54) BATTERY BOX

(71) Applicant: Nanning FuLian FuGui Precision Industrial Co., Ltd., Nanning (CN)

(72) Inventor: TIAN-HONG LUO, Nanning (CN)

(21) Appl. No.: 18/892,830

(22) Filed: Sep. 23, 2024

(30) Foreign Application Priority Data
Aug. 28, 2024 (CN) 202411195342.3

(51) Int. Cl. H01M 50/267; H01M 50/242; H01M 50/264; H01M 50/271

(52) U.S. Cl. CPC H01M 50/267; H01M 50/264; H01M 50/271; H01M 50/242

(57) ABSTRACT

A battery box includes a housing, a rotation element, a fixture element, position elements, and connection elements. The rotation element is disposed in the housing. The fixture element is disposed on the rotation element, and includes guide holes. The position element is disposed on the fixture element, and includes movement shafts extending through the guide holes. The connection elements are connected to the rotation elements and movement shafts. The battery is configured to be placed between the position elements. When the rotation element is rotated, the connection elements move the position elements.

### FIELD

The subject matter herein generally relates to battery boxes.

### BACKGROUND

Batteries are used to be installed in a mobile device to provide power to the mobile device. In order to facilitate battery replacement, a battery box is usually set up in the mobile device to allow batteries with fixed specifications to be installed in the battery groove of the battery box. In addition, the battery groove in the battery box needs to match the size of the battery to prevent the battery from shifting in the battery groove and thereby separating from the electrodes of the battery box.

However, the battery in the battery box may become swollen due to factors such as service life or defects. In particular, rechargeable batteries become swollen due to excessive charging and discharging. Users usually install the battery when the battery is new or fully charged, and then remove it after a period of time when the battery is out of power or has insufficient power. At this time, the battery may be swollen and become stuck in the battery groove, making it difficult to remove and replace it, resulting in the inability to provide power to the mobile device.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a perspective view of a battery box 1 in accordance with a first embodiment of the present disclosure.

FIG. 2 is an exploded view of the battery box 1 shown in FIG. 1.

FIG. 3 is a cross-sectional view of the battery box 1 shown in FIG. 1.

FIG. 4 is a perspective view of a portion of the battery box 1 shown in FIG. 1.

FIG. 5 is a perspective view of the battery box 1 in accordance with the first embodiment of the present disclosure.

FIG. 6 is a cross-sectional view of the battery box 1 shown in FIG. 5.

FIG. 7 is a perspective view of a portion of the battery box 1 shown in FIG. 5.

FIG. 8 is a perspective view of a battery box 1 in accordance with a second embodiment of the present disclosure.

FIG. 9 is an exploded view of the battery box 1 shown in FIG. 8.

FIG. 10 is a perspective view of a portion of the battery box 1 shown in FIG. 8.

FIG. 11 is a perspective view of another portion of the battery box 1 shown in FIG. 8.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connect” is defined as directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

In the present disclosure, swollen batteries can be easily taken out from the battery box by changing the size of the battery groove in the battery box.

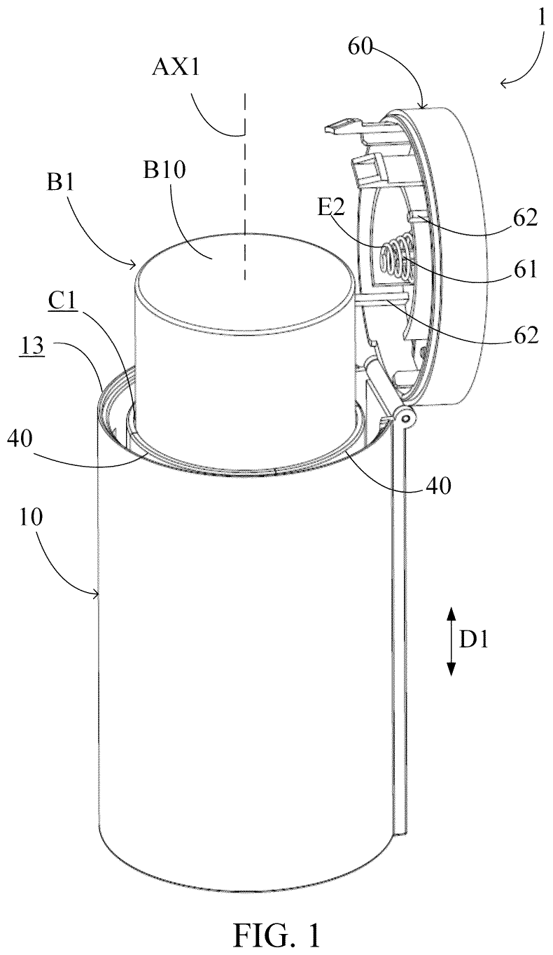

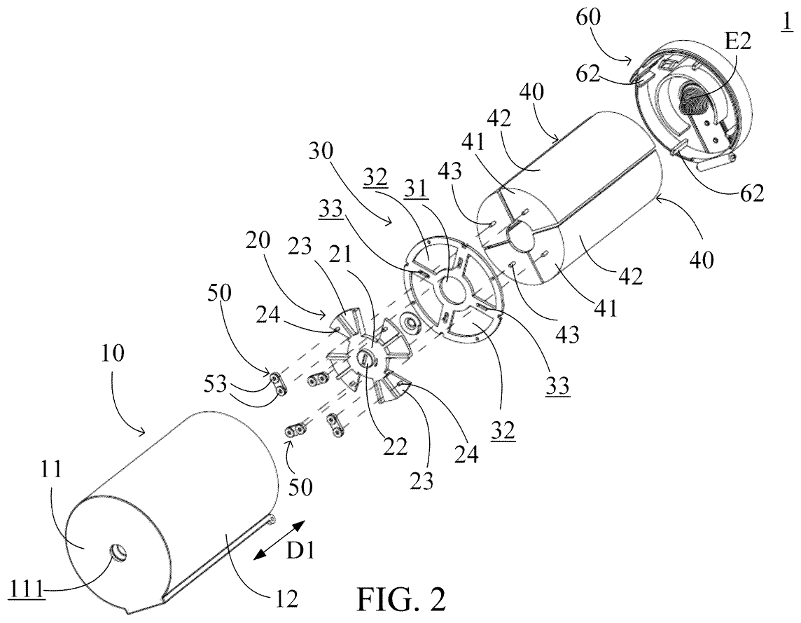

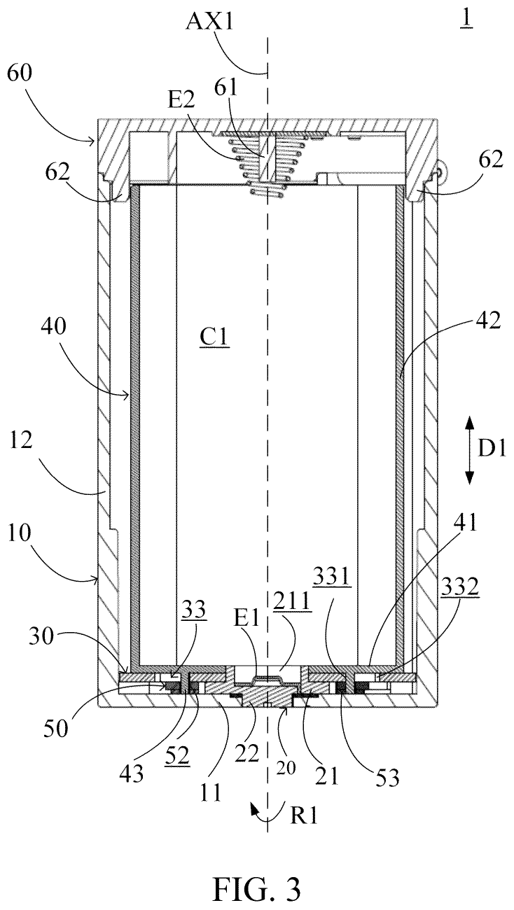

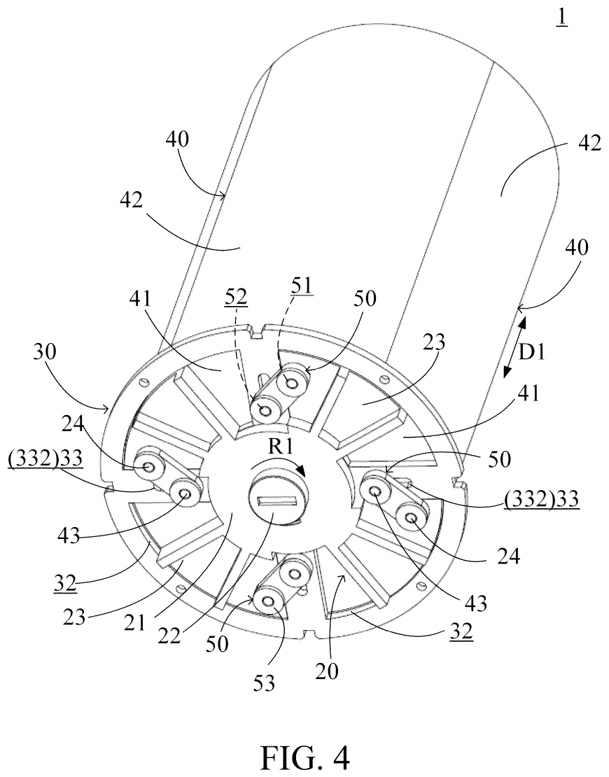

FIG. 1 is a perspective view of a battery box 1 in accordance with a first embodiment of the present disclosure. In FIG. 1, the cover 60 is in an opening position, and the position element 40 is in a storage position. FIG. 2 is an exploded view of the battery box 1 shown in FIG. 1. FIG. 3 is a cross-sectional view of the battery box 1. In FIG. 3, the cover 60 is in a closed position, and the position element 40 is in the storage position. FIG. 4 is a perspective view of part of the battery box 1 shown in FIG. 1. In FIG. 4, the position element 40 is in the storage position.

The battery box 1 receives one or more batteries B1. The battery B1 may be a dry battery or a cylindrical battery, but not limited thereto. The battery box 1 can be electrically connected to an electronic device, and provide power to the electronic device. Moreover, the battery box 1 can be integrated into the electronic device, or detachably installed in the electronic device. In this embodiment, the battery B1 is placed in a battery groove C1 formed by the position elements 40. When the battery B1 are swollen or stuck in the battery groove C1, the battery groove C1 can be expanded by moving the position elements 40 to facilitate the user to take out the battery B1 from the battery groove C1.

The battery box 1 includes a housing 10, a rotation element 20, a fixture element 30, a position element 40, connection elements 50, and a cover 60. The housing 10 may be a hollow cylindrical structure, extending in an extension direction D1. The housing 10 includes a bottom 11 and a side wall 12. The bottom 11 includes a through hole 111. The through hole 111 is located at the center of the bottom 11. The bottom 11 extends perpendicular to the extension direction D1, and can be a plate structure. The side wall 12 is connected to the bottom 11, and can be an annular structure. The side wall 12 extends perpendicular to the bottom 11, and extends in the extension direction D1. Moreover, the housing 10 includes an opening 13, located at one end of the side wall 12 and opposite to the bottom 11. The battery B1 can be placed in to the housing 10 via the opening 13. In this embodiment, an imaginary central axis AX1 is parallel to the extension direction D1, and extends through the center of the housing 10. The imaginary central axis AX1 extends through the centers of the bottom 11 and the through hole 111, and the side wall 12 surrounds the imaginary central axis AX1.

The rotation element 20 is rotatably disposed in the housing 10, and contacts the bottom 11. The imaginary central axis AX1 extends through the center of the rotation element 20, and the rotation element 20 can be rotated about the imaginary central axis AX1. Moreover, the rotation element 20 extends perpendicular to the imaginary central axis AX1. The rotation element 20 includes a central portion 21, a rotation portion 22, extension portions 23, and transmission shafts 24. The central portion 21, the rotation portion 22, the extension portions 23, and the transmission shafts 24 may be an integral structure, and made of the same materials, such as plastic or metal. The imaginary central axis AX1 extends through the center of the central portion 21, and the central portion 21 can be rotated about the imaginary central axis AX1.

As shown in FIG. 3, the central portion 21 includes an electrode groove 211. The battery box 1 further includes a first electrode element E1 disposed in a bottom of the electrode groove 211. The depth of the electrode groove 211 is greater than the thickness of the first electrode element E1, and the depth and the thickness are measured in the same extension direction D1. Therefore, when the battery B1 is correctly placed in the battery groove C1, the positive pole of the battery B1 can enter into the electrode groove 211 and contacts the first electrode element E1. However, when the battery B1 is incorrectly placed in the battery groove C1, the negative pole B10 of the battery B1 (as shown in FIG. 1) cannot contact the first electrode element E1 within the electrode groove 211. Therefore, the design of the central portion 21 can prevent the negative pole B10 of the battery B1 from contacting the first electrode element E1 in the electrode groove 211 after the battery B1 is placed in the battery groove C1 in the wrong direction.

The rotation portion 22 is disposed on the central portion 21, and is in the through hole 111 of the bottom 11. Therefore, the user can use a tool to rotate the rotation portion 22 from the outside of the housing 10, thereby rotating the rotation element 20. The extension portions 23 are respectively connected to the central portion 21. The extension portions 23 surrounds the central portion 21, and are separated from each other. The extension portions 23 extend perpendicular to the extension direction D1. In other words, an imaginary plane, which is perpendicular to the imaginary central axis AX1, extends through the central portion 21 and the extension portions 23. Each transmission shaft 24 is connected to one extension portion 23. The transmission shafts 24 are parallel to each other, and extend in the extension direction D1.

The fixture element 30 is disposed on the rotation element 20. In this embodiment, the fixture element 30 is affixed in the housing 10. The imaginary central axis AX1 extends through the center of the fixture element 30. Moreover, the fixture element 30 may be a plate structure, and extends perpendicular to the imaginary central axis AX1. The fixture element 30 includes a central hole 31, restriction holes 32, and guide holes 33. The central hole 31 is at the center of the fixture element 30, and the imaginary central axis AX1 extends through the central hole 31. The central portion 21 is rotatably disposed in the central hole 31. The restrictions hole 32 and the guide holes 33 are alternately arranged surrounding the central hole 31. In other words, each guide hole 33 are between two of the restriction holes 32.

Each extension portion 23 is movably and respectively disposed one of the restriction holes 32. The restriction holes 32 restrict the rotation angle of the rotation element 20. In one imaginary plane, which is perpendicular to the imaginary central axis AX1, the area of each restriction hole 32 is greater than the area of each extension portion 23. Each guide hole 33 is an elongated shape, which extends toward the imaginary central axis AX1.

The position elements 40 are movably disposed on the fixture element 30. A battery groove C1 is formed by the position elements 40, and a battery B1 can be placed in the battery groove C1. Each position element 40 includes a support portion 41, a blocking portion 42, and a movement shafts 43. The support portion 41 extends perpendicular to the extension direction D1. The blocking portion 42 extends perpendicular to the support portion 41. Moreover, the blocking portion 42 includes a curved surface, corresponding to the shape of the battery B1. The movement shafts 43 are respectively connected to the support portion 41, and surround the imaginary central axis AX1. Moreover, the movement shafts 43 respectively extend through the guide holes 33 in the extension direction D1.

Each connection element 50 is connected to one transmission shaft 24 and one movement shaft 43. When the rotation element 20 is rotated, each connection element 50 moves one position elements 40. Moreover, the connection elements 50 surround the imaginary central axis AX1, and are separated to each other. Each connection element 50 includes a first shaft hole 51 and a second shaft hole 52. The transmission shaft 24 is rotatably disposed in the first shaft hole 51, and the movement shaft 43 is rotatably disposed in the second shaft hole 52. Each connection element 50 further includes two shaft sleeves 53 respectively affixed to the free ends of the transmission shaft 24 and the movement shaft 43. The shaft sleeves 53 can prevent the connection elements 50 from being separated from the transmission shafts 24 and the movement shafts 43.

The cover 60 is connected to the housing 10. In this embodiment, the cover 60 is pivoted to the housing 10. When the cover 60 is in the opening position shown in FIG. 1, the cover 60 is separated from the opening 13 and the housing 10. When the cover 60 is in the closed position shown in FIG. 3, the cover 60 covers the opening 13 of the housing 10. The cover 60 includes an abutting rod 61, which extends in the extension direction D1. The battery box 1 further includes a second electrode element E2 disposed on the cover 60, and surrounds the abutting rod 61. In this embodiment, the second electrode element E2 may be a spring. The high of the second electrode element E2 is greater than the length of the abutting rod 61. The high of the second electrode element E2 and the length of the abutting rod 61 are measured in the same extension direction D1.

When the battery B1 is correctly placed in the battery groove C1, the negative pole B10 of the battery B1 (as shown in FIG. 1) contact the second electrode element E2, and the cover 60 can fit well on the housing 10. However, when the battery B1 is incorrectly placed in the battery groove C1, and the cover 60 covers the housing 10, the positive pole of the battery B1 abuts the abutting rod 61, resulting in the cover 60 not being able to cover the housing 10 well. Therefore, the abutting rod 61 can prevent the battery B1 from being placed in the battery groove C1 in the wrong direction.

The cover 60 further includes blocking ribs 62. The blocking ribs 62 respectively extend perpendicular to the extension direction D1. When the cover 60 covers the housing 10, and the position element 40 is in the storage position shown in FIG. 1, each blocking rib 62 adjacent to or contacts one position element 40 to prevent the position elements 40 from moving to the expansion position, so that the position elements 40 can well hold the battery B1 in the battery groove C1.

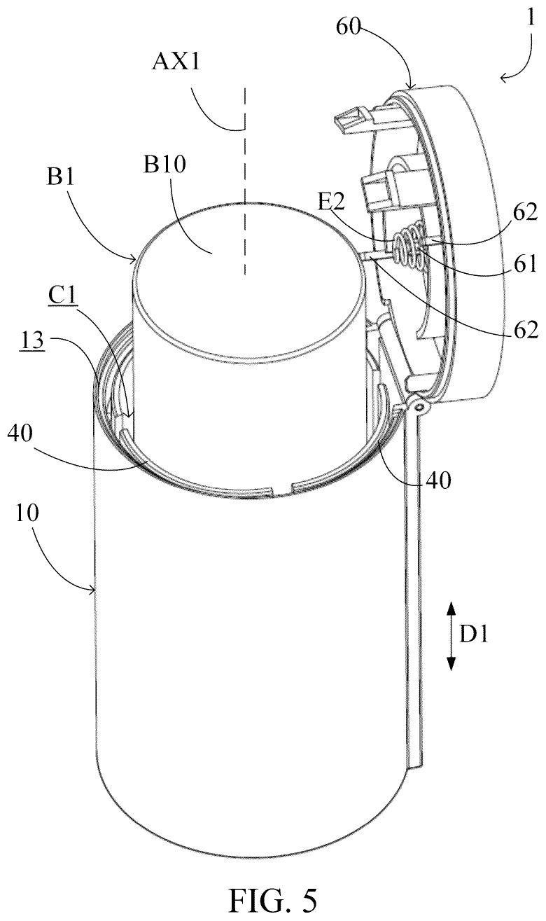

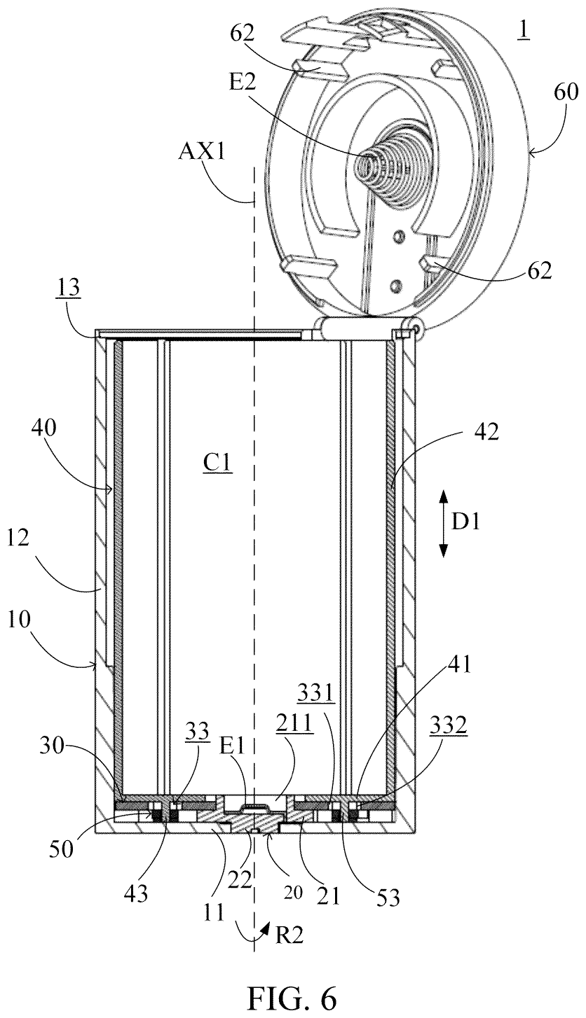

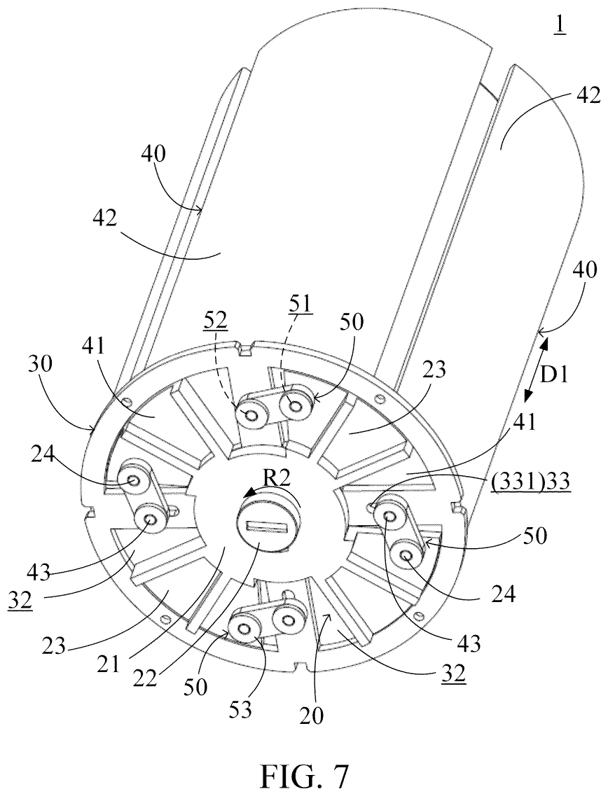

FIG. 5 is a perspective view of the battery box 1 in accordance with the first embodiment of the present disclosure. In FIG. 5, the cover 60 is in the opening position, and the position element 40 is in the expansion position. FIG. 6 is a cross-sectional view of the battery box 1. In FIG. 6, the cover 60 is in the opening position, and the position element 40 is in the expansion position. FIG. 7 is a perspective view of part of the battery box 1 shown in FIG. 5. In FIG. 7, the position element 40 is in the expansion position.

As shown in FIG. 1, FIG. 3 and FIG. 4, When the battery B1 are swollen or stuck in the battery groove C1, the user can open the cover 60 relative to the housing 10 to move the blocking ribs 62 away from the blocking portions 42 of the position element 40, so that the position element 40 can be moved in the housing 10. Afterward, the user rotates the rotation portion 22 in the first rotation direction R1, so that the rotation element 20 rotates relative to the fixture element 30. At this time, the extension portions 23 are moved in the first rotation direction R1 in the restriction holes 32, and the transmission shafts 24 are also moved in the first rotation direction R1. When the transmission shafts 24 are moved in the first rotation direction R1, the transmission shafts 24 drive the connection elements 50 to move, and the connection elements 50 move the movement shafts 43 from the first ends 331 of the guide holes 33 in FIG. 3 and FIG. 4 to the second ends 332 of the guide holes 33 in FIG. 5 and FIG. 7. In this embodiment, the guide holes 33 respectively extend toward the imaginary central axis AX1, and the first ends 331 of the guide holes 33 is closer to the imaginary central axis AX1 than the second ends 332 of the guide holes 33.

When the movement shaft 43 is moved from the first end 331 of the guide hole 33 to the second end 332 of the guide hole 33, the movement shaft 43 drives the position element 40 to move away from the imaginary central axis AX1. In other words, when the rotation element is rotated in the first rotation direction R1, the position elements 40 are moved from the storage position close to the imaginary central axis AX1 (as shown in FIGS. 1, 3 and 4) to the expansion position away from the imaginary central axis AX1 (as shown in FIGS. 5, 6 and 7). In the expansion position, the battery groove C1 is expanded by the position elements 40 respectively far away from the imaginary central axis AX1. Therefore, the user can easily take out the battery B1 from the battery box 1.

Afterward, when the user wants to place the battery B1 in the battery box 1, the user can turn the rotation portion 22 in the second rotation direction R2 to rotate the rotation element 20 relative to the fixture element 30, and the position element 40 are moved from the storage position to the expansion position. Therefore, the battery B1 can be placed stably in the battery box 1.

When the position elements 40 are in the storage position shown in FIGS. 1, 3 and 4, each position element 40 is connected to another position element 40. In other word, the position elements 40 are arranged in a circular path. In the circular path, two adjacent support portions 41 of the position elements 40 are connected, and two adjacent blocking portions 42 are connected. The battery groove C1 corresponds to the volume of the battery B1, so that the battery B1 can be firmly placed in the battery groove C1, and the battery B1 can have good contact with the first electrode element E1 and the second electrode element E2 of the battery box 1. When the position elements 40 are in the expansion position shown in FIGS. 5, 6 and 7, the support portions 41 of the position elements 40 are separated from each other, and the blocking portions 42 are separated from each other. Therefore, the volume of battery groove C1 is increased, the expanded battery B1 can be easily taken out from the battery box 1.

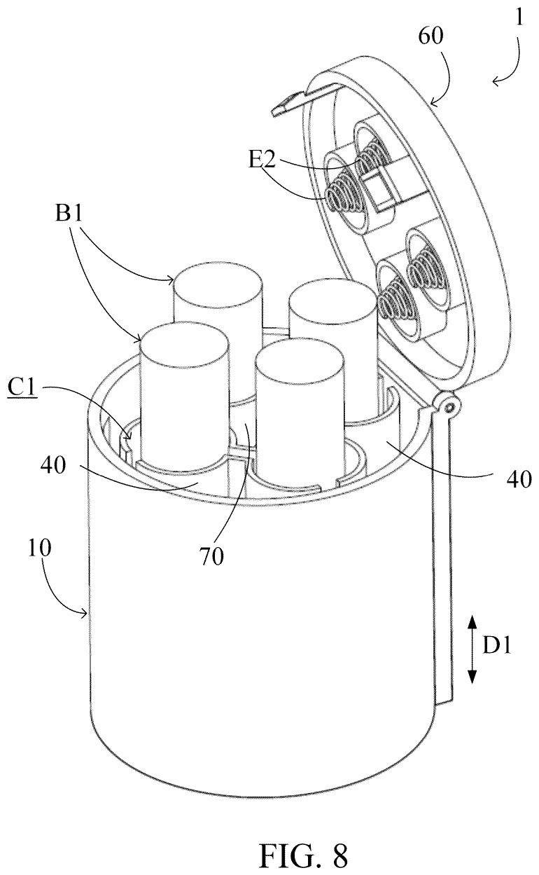

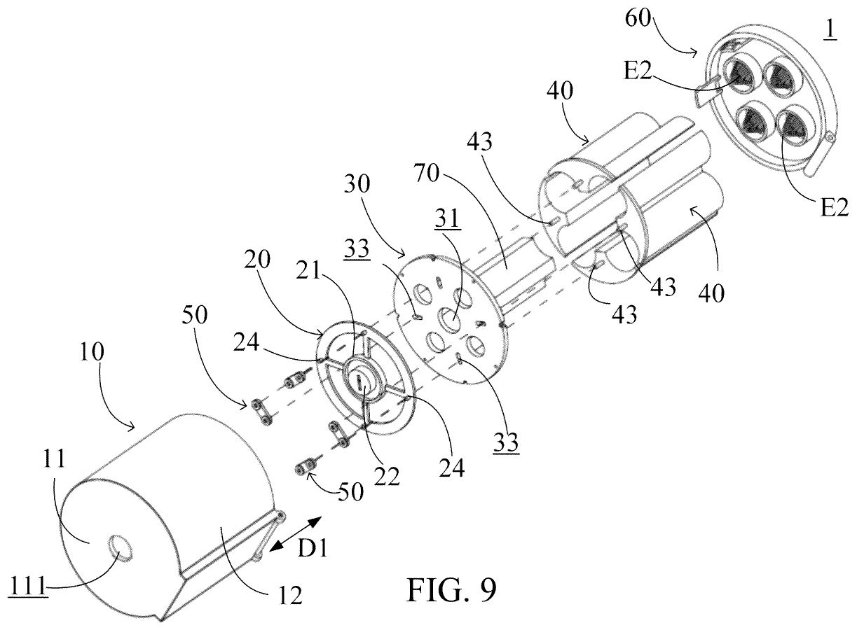

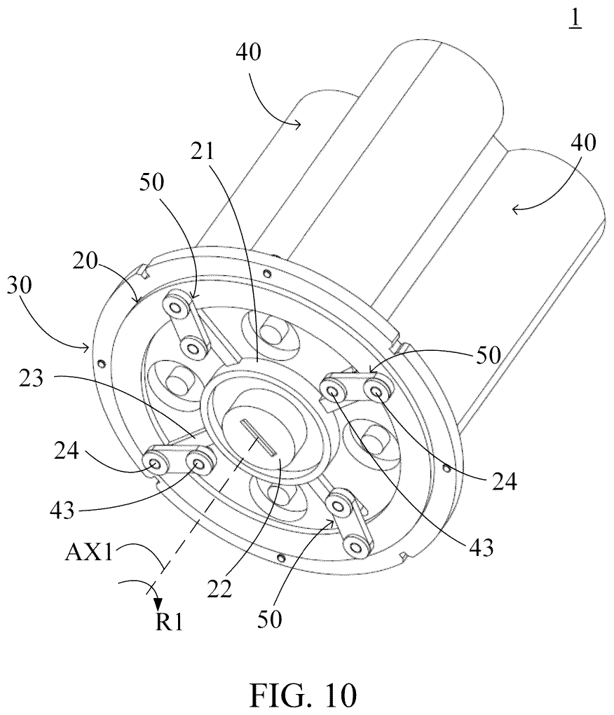

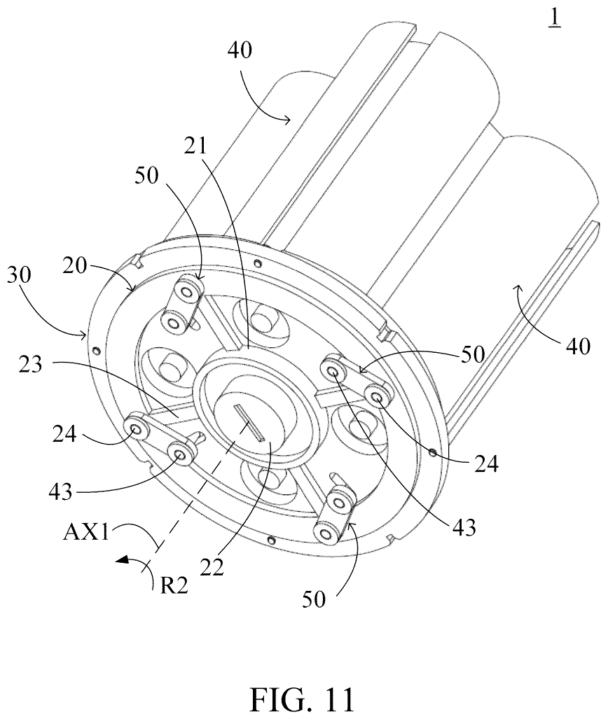

FIG. 8 is a perspective view of a battery box 1 in accordance with a second embodiment of the present disclosure. FIG. 9 is an exploded view of the battery box 1 shown in FIG. 8. FIG. 10 is a perspective view of part of the battery box 1 shown in FIG. 8. In FIG. 10, the position element 40 is in a storage position. FIG. 11 is a perspective view of part of the battery box 1 shown in FIG. 8. In FIG. 11, the position element 40 is in an expansion position.

In this embodiment, the battery box 1 receives batteries B1. The battery box 1 further includes a separation column 70 between the position elements 40. The separation column 70 extends along the imaginary central axis AX1, and includes curved surfaces. Each curved surface corresponds to the shape of one battery B1. The battery grooves C1 are formed between the separation column 70 and the position elements 40. The batteries B1 are placed between the separation column 70 and the position elements 40, and each battery B1 is in one battery groove C1. When the rotation portion 22 is rotated in the first rotation direction R1, the connection elements 50 drives the position elements 40 from the storage position shown in FIG. 10 to the expansion position far away the separation column 70 shown in FIG. 11.

In the present disclosure, the battery box 1 of the present disclosure increases the volume of the battery groove C1 by rotating the rotation element 20 and moving the position element 40, so that the expanded battery B1 can be easily taken out of the battery box 1.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A battery box comprising:
a housing;
a rotation element disposed in the housing;
a fixture element disposed on the rotation element, and comprising a plurality of guide holes;
a plurality of position elements disposed on the fixture element, and each comprising a plurality of movement shafts extending through a corresponding guide hole of the guide holes; and
a plurality of connection elements connected to the rotation element and a corresponding movement shaft of the movement shafts,
wherein the plurality of position elements is arranged to accommodate a battery therein between, and
when the rotation element is rotated, the plurality of connection elements moves the plurality of position elements.

2. The battery box as claimed in claim 1, wherein the rotation element further comprises a plurality of transmission shafts, each of the plurality of connection elements comprise a plurality of first shaft holes and a plurality of second shaft holes, each of the plurality of transmission shafts is in a corresponding first shaft hole of the first shaft holes, and each of the plurality of movement shafts is in a corresponding second shaft hole of the plurality of second shaft holes.

3. The battery box as claimed in claim 2, the connection elements further comprise a plurality of shaft sleeves affixed to free ends of the plurality of transmission shafts and plurality of the movement shafts.

4. The battery box as claimed in claim 2, the rotation element further comprising:
a central portion; and
a plurality of extension portions connected to the central portion;
wherein the plurality of transmission shafts is connected to the plurality of the extension portions.

5. The battery box as claimed in claim 4, wherein the fixture element further comprises a plurality of restriction holes, the plurality of extension portions is movably disposed in the plurality of the restriction holes, and the plurality of restriction holes is configured to restrict a rotation angle of the rotation element.

6. The battery box as claimed in claim 4, further comprising a first electrode element, wherein the central portion further comprises an electrode groove, the first electrode element is placed in the electrode groove, a depth of the electrode groove is greater than a thickness of the first electrode element, and the depth of the electrode groove and the thickness of the first electrode element are measured in a same direction.

7. The battery box as claimed in claim 4, wherein the fixture element further includes a central hole, and the central portion is rotatably disposed in the central hole.

8. The battery box as claimed in claim 4, wherein the housing further comprises a through hole, the rotation element further comprises a rotation portion, and the rotation portion is disposed on the central portion, and in the through hole.

9. The battery box as claimed in claim 1, wherein each of the plurality of position elements further comprises a plurality of support portions and a plurality of blocking portions, the corresponding movement shaft is connected to a corresponding support portions of the plurality of support portions, and each of the plurality of blocking portions extends perpendicular to the corresponding support portion.

10. The battery box as claimed in claim 1, wherein an imaginary central axis extends through a center of the rotation element and a center of the fixture element, each of the plurality of guide holes respectively extends toward the imaginary central axis, and the plurality of position elements surrounds the imaginary central axis.

11. The battery box as claimed in claim 10, wherein the fixture element extends perpendicular to the imaginary central axis, and the plurality of guide holes, the plurality of movement shafts, and the plurality of connection elements surround the imaginary central axis.

12. The battery box as claimed in claim 1, wherein when the plurality of position elements is in a storage position, each of the plurality of position elements is respectively connected to another position element of the plurality of position elements, and
when the plurality of position elements is in an expansion position, the plurality of position elements is connected to each other.

13. The battery box as claimed in claim 1, further comprising:
a cover connected to the housing, and comprising an abutting rod;
a second electrode element disposed on the cover, and surrounding the abutting rod.

14. The battery box as claimed in claim 13, wherein the cover further comprises a plurality of blocking ribs, and the plurality of blocking ribs is adjacent to the plurality of position elements when the cover covers the housing, and the plurality of position elements is in a storage position.

15. A battery box comprising:
a housing;
a rotation element disposed in the housing;
a fixture element disposed on the rotation element, and comprising a guide hole;
a position element disposed on the fixture element, and comprising a movement shaft extending through the guide hole; and
a connection element connected to the rotation element and the movement shaft,
wherein when the rotation element is rotated, the connection element moves the position element.
